(19) United States
(12) Patent Application Publication
(10) Pub. No.: US 2022/0203581 A1
(43) Pub. Date: Jun. 30, 2022

(54) MOLDING LINE AND MANUFACTURING APPARATUS THEREOF

(71) Applicant: Zhejiang Jihengkang (JHK) Door Industry Co., Ltd., Jinhua (CN)

(72) Inventor: Chen ZHOU, Jinhua (CN)

(73) Assignee: Zhejiang Jihengkang (JHK) Door Industry Co., Ltd., Jinhua (CN)

(21) Appl. No.: 17/655,139

(22) Filed: Mar. 16, 2022

Related U.S. Application Data
(63) Continuation of application No. PCT/CN2021/140894, filed on Dec. 23, 2021.

(30) Foreign Application Priority Data
Dec. 23, 2020 (CN) 202011548740.0

(51) Int. Cl. B29C 43/02

(52) U.S. Cl. CPC B29C 43/021; B29C 2043/022

(57) ABSTRACT

A molding line and a manufacturing apparatus thereof are disclosed. The molding line includes a line body extending along a first direction. The line body includes a first and a second modeling layer part and a connecting part. In a cross section perpendicular to the first direction, the first and second modeling layer part extend along a second direction, the first modeling layer part is located at an outer side opposite to the second modeling layer part, and the connecting part is connected between the first modeling layer part and the second modeling layer part and obliquely intersects with the second direction. An inwardly recessed molding groove is provided at a joint of the connecting part and the first molding layer part or/and the second molding layer part. The disclosure has advantages of providing a molding line with more stereoscopic and aesthetic visual effect and a manufacturing apparatus thereof.

### CROSS-REFERENCE TO RELATED APPLICATIONS

This application is a continuation of International Application No. PCT/CN2021/140894 filed 23 Dec. 2021, which claims the benefit of priority to Chinese Application No. 202011548740.0, filed 23 Dec. 2020, the benefit of priority of each of which is claimed herein and which applications are hereby incorporated by reference herein in their entirety.

### TECHNICAL FIELD

The disclosure relates to decorative lines and manufacturing apparatus thereof, in particular to a molding line and a manufacturing apparatus thereof.

### BACKGROUND ART

Molding is an abbreviation of compression molding, also known as compression moulding; or a plastic processing (also rubber processing) method in which plastics or rubber compounds are molded into articles by heating and pressurizing in a closed mold cavity. In order to prevent wooden doors from being stiff and be capable, or can be embedded in mirrors or glass, manufacturers often use decorative lines on doors to increase aesthetics of the wooden doors.

Existing lines have obvious molding effect, and the modeling lines are round and not contracted enough.

### SUMMARY

In order to solve shortcomings of the prior art, a molding line is provided in the disclosure, which includes a line body extending along a first direction. The line body includes a first modeling layer part, a second modeling layer part and a connecting part. In a cross section perpendicular to the first direction, the first modeling layer part and the second modeling layer part extend along a second direction, the first modeling layer part is located at an outer side opposite to the second modeling layer part, and the connecting part is connected between the first modeling layer part and the second modeling layer part and obliquely intersects with the second direction. An inwardly recessed molding groove is provided at a joint of the connecting part and the first molding layer part or/and the second molding layer part.

Further, the molding groove is a V-shaped groove.

Further, the molding groove extends along the first direction.

Further, the connecting part is of a linear structure.

Further, the connecting part is of an arc structure.

In order to facilitate processing of molding lines as described above, a manufacturing apparatus of the molding line is further provided in the disclosure, which includes a disposing seat (1), a supporting leg (2), a buffer mechanism, a disposing plate (6), a disposing shell (7), a limiting and clamping mechanism and a punching mechanism. A bottom surface of the disposing seat (1) is fixedly connected with a top end surface of the supporting leg (2), a top surface of the disposing seat (1) is fixedly connected with a bottom surface of the buffer mechanism, a top surface of the buffer mechanism is fixedly connected with a bottom surface of the disposing plate (6), and a top surface of the disposing plate (6) is fixedly connected with a bottom surface of the disposing shell (7), and a through hole (701) is defined on two opposite side surfaces of the disposing shell (7), and a line body (15) is disposed on the top surface of the disposing plate (6).

The buffer mechanism comprises a fixed frame (3), a chute (301), a supporting post (5) and a shock absorbing tube (4), a top surface of the fixed frame (3) being defined with the chute (301), a side surface of the fixed frame (3) being in sliding contact with two opposite end surfaces of the shock absorbing tube (4), and an inner cavity of the chute (301) being in sliding connection with the supporting post (5), a top end surface of the supporting post (5) being fixedly connected with a bottom surface of the disposing plate (6), and a bottom end surface of the supporting post (5) being fixedly connected with a top surface of the shock absorber tube (4) made of elastic alloy steel.

The limiting and clamping mechanism comprises a fixed plate (8), a threaded rod (9), a rotating plate (10), a rotating rod (11), a pressing plate (12), a first electric push rod (13) and a limiting plate (14), the fixed plate (8) being fixedly connected to the two opposite side surfaces of the disposing shell (7), and a surface of the fixed plate (8) being threadedly connected with the threaded rod (9), a top end surface of the threaded rod (9) being fixedly connected with a bottom surface of the rotating plate (10), a top surface of the rotating plate (10) being fixedly connected with a bottom end surface of the rotating rod (11), a bottom end of the threaded rod (9) being rotatably connected with a top surface of the pressing plate (12), the pressing plate (12) being slidably connected to an inner cavity of the through hole (701), two opposite side surfaces of the through hole (701) on a left side of the disposing shell (7) being provided with the first electric push rod (13), and the first electric push rod (13) being fixedly connected to a side surface of the disposing shell (7), and a output end of the first electric push rod (13) being fixedly connected to a side surface of the limiting plate (14).

The punching mechanism comprises a hydraulic cylinder (16), a clamping shell (17), a second electric push rod (18), a clamping plate (19) and a sponge pad (20), the hydraulic cylinder (16) being fixedly connected to a middle of the top surface of the disposing shell (7), and an output end of the hydraulic cylinder (16) being fixedly connected to a top surface of the clamping shell (17), two opposite side surfaces of the clamping shell (17) being fixedly connected with the second electric push rod (18), an output end of the second electric push rod (18) being fixedly connected with the clamping plate (19), and the other side surface of the clamping plate (19) being fixedly connected with the sponge pad (20).

Further, there are four supporting legs (2), and the four supporting legs (2) are located at four corners of a bottom side of the disposing seat (1).

Further, there are a number of the shock absorbing tubes (4), and adjacent shock absorbing tubes (4) are equally spaced and distributed in parallel, and the shock absorbing tubes (4) are slidably connected with the side surface of the fixed frame (3).

Further, top surfaces of two opposite ends of the shock absorbing tube (4) are fixedly connected with the supporting post (5), and the supporting posts (5) fixedly connected to the top sides of the shock absorbing tube (4) are parallel.

Further, two opposite side surfaces of the line body (15) are attached to the limiting plate (14), and a thickness of the limiting plate (14) is less than that of the line body (15).

The disclosure has advantages of providing a molding line with more stereoscopic and aesthetic visual effect and a manufacturing apparatus thereof.

### BRIEF DESCRIPTION OF THE DRAWINGS

Accompanying drawings, which form a part of this disclosure, are used to provide a further understanding of this disclosure and make other features, objects and advantages of this disclosure more obvious. Illustrative embodiments of this disclosure, drawings and their descriptions are intended to explain this disclosure and do not constitute undue restrictions on this disclosure. In the drawings:

FIG. 1 is a schematic structural diagram of a molding line according to an embodiment of the present disclosure;

FIG. 2 shows a molding line of various embodiments under a design idea of this disclosure.

FIG. 3 is an overall schematic structural diagram of a manufacturing apparatus according to an embodiment of this disclosure;

FIG. 4 is an overall schematic structural diagram of a manufacturing apparatus according to an embodiment of the disclosure;

FIG. 5 is a schematic diagram of a surface structure of a through hole on a left side of a disposing shell of the manufacturing apparatus according to an embodiment of the disclosure;

FIG. 6 is a schematic diagram of a surface structure of a through hole on a right side of a disposing shell of the manufacturing apparatus according to an embodiment of the disclosure;

FIG. 7 is a partially enlarged schematic structural diagram at A in FIG. 3 according to an embodiment of the present disclosure;

FIG. 8 is a partially enlarged schematic structural diagram at B in FIG. 4 according to an embodiment of the present disclosure;

FIG. 9 is a schematic structural diagram of a bottom surface of a clamping shell of a manufacturing apparatus according to an embodiment of the disclosure; and

FIG. 10 is a structural diagram of a top surface of a fixed frame of a manufacturing apparatus according to an embodiment of the present disclosure.

### DETAILED DESCRIPTION

In order to make the skilled in the art better understand the schemes of the disclosure, the technical schemes in the embodiments of this disclosure will be described clearly and completely with reference to the drawings in the embodiments of this disclosure; and it is obvious that the described embodiments are only part of the embodiments of this disclosure, but not all of them. On a basis of the embodiments in this disclosure, all other embodiments obtained by the ordinary skilled in the art without any creative effort should be within the protection scope of this disclosure.

It should be noted that terms “first”, “second” and so on in the specification and claims of this disclosure and the above drawings are used to distinguish similar objects, but not necessarily to describe a specific order or sequence. It should be understood that the data thus used can be interchanged under appropriate circumstances to facilitate embodiments of the present disclosure described herein. In addition, terms “including” and “having” and any variations thereof are intended to cover non-exclusive inclusion, for example, a process, method, system, product or apparatus containing a series of steps or units need not be limited to those steps or units explicitly listed, but may include other steps or units not explicitly listed or inherent to these processes, methods, products or apparatus.

In this application, an azimuth or positional relationship indicated by terms “upper”, “lower”, “left”, “right”, “front”, “back”, “top”, “bottom”, “inner”, “outer”, “middle”, “vertical”, “horizontal”, “transverse” and “longitudinal” or the like is based on an azimuth or positional relationship shown in the drawings. These terms are mainly used to better describe the disclosure and its embodiments, and are not used to limit that the indicated apparatus, element or component must have a specific orientation, or be constructed and operated in a specific orientation.

In addition, some of the above terms can be used to indicate not only the azimuth or positional relationship, but also the other meaning. For example, the term “on” may also be used to indicate some attachment or connection relationship in some cases. For those ordinary skilled in the art, specific meanings of these terms in this application can be understood according to specific situations.

In addition, terms “installed”, “disposed”, “provided”, “connected”, “coupled” and “sleeved” should be understood broadly. For example, it can be a fixedly connected, a detachably connected, or integrally constructed; it can be mechanically or electrically connected; it can be directly connected, indirectly connected through an intermediate medium, or internally communicated between two apparatus, elements or components. For those ordinary skilled in the art, the specific meanings of the above terms in this application can be understood according to specific situations.

It should be noted that the embodiments in the present application and the characteristics in the embodiments can be combined mutually in the case of no conflict. The present invention will be described in detail with reference to drawings and in combination with embodiments.

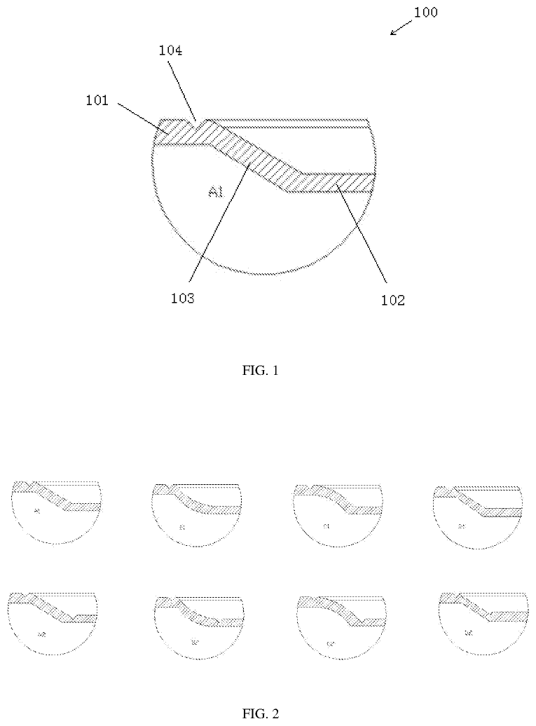

Referring to FIGS. 1 and 2, the molding line (can also be called molding strip) includes a line body 100 extending along a first direction.

Specifically, the line body 100 includes a first modeling layer part 101, a second modeling layer part 102 and a connecting part 103.

In a cross section perpendicular to the first direction, the first modeling layer part 101 and the second modeling layer part 102 extend along a second direction, the first modeling layer part 101 is located at an outer side opposite to the second modeling layer part 102, and the connecting part 103 is connected between the first modeling layer part 101 and the second modeling layer part 102 and obliquely intersects with the second direction. An inwardly recessed molding groove 104 is provided at a joint of the connecting part 103 and the first molding layer part 101 or/and the second molding layer part 102.

Specifically, the molding groove 104 is a V-shaped groove. Of course, the molding groove also can be constructed with other cross-sectional shapes.

Specifically, the molding groove 104 extends in the first direction. That is, it extends in a direction of the line body 100.

As shown in FIG. 2, the connecting part 103 may be of a linear structure. Alternatively, the connecting part 103 is of an arc structure.

With the above scheme, following technical effects can be achieved: a. compared with original line effect, the invented line presents a more generous style and is closer to a trend of modern development. b. An angular visual effect of this new line is more square, which can be contracted by 15 to 50 decimillimetres without increasing processing difficulty. c. The new line has effect of imitating a solid wood splicing door. d. It increases structure stability, and has parts that can be molded and embedded with mirrors or glass.

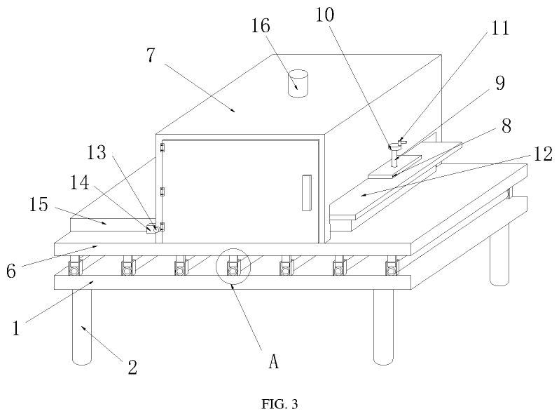

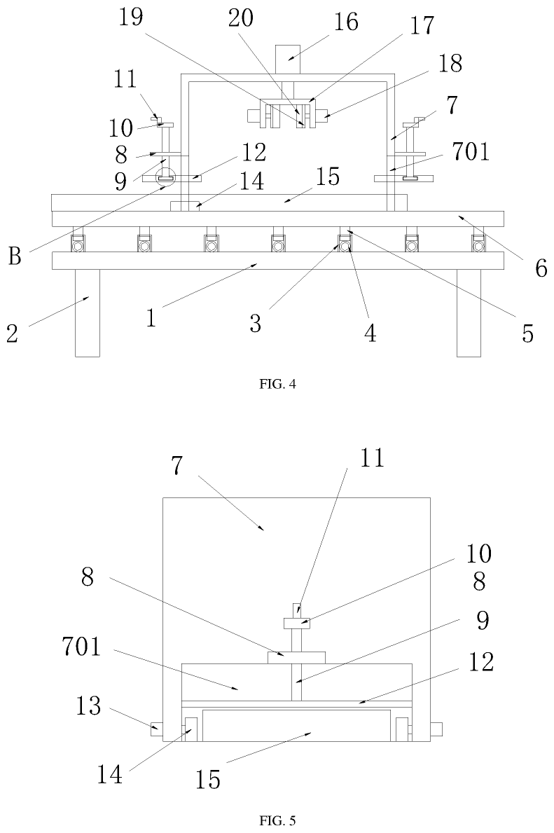

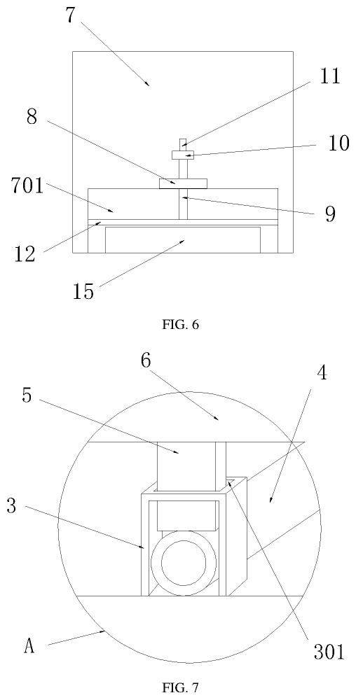

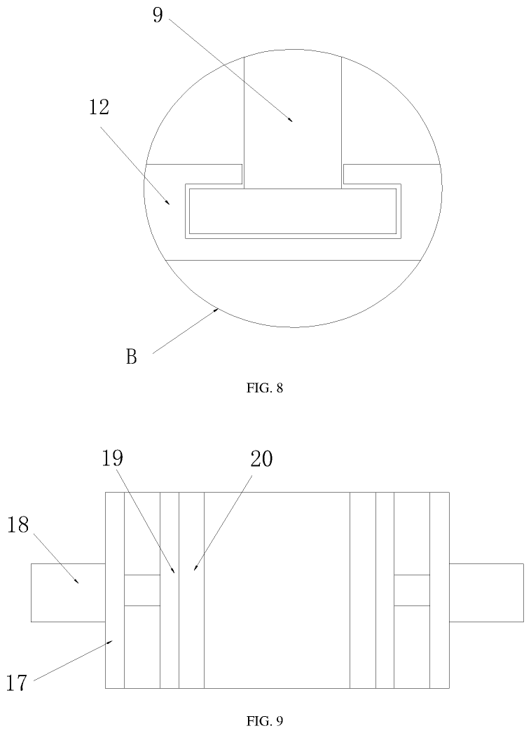

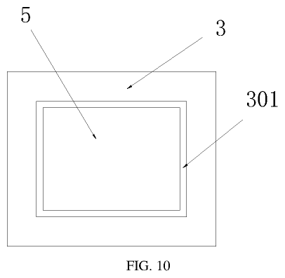

Referring to FIGS. 3 to 10, a manufacturing apparatus of the molding line includes a disposing seat 1, supporting legs 2, a buffer mechanism, a disposing plate 6, a disposing shell 7, a limiting and clamping mechanism and a punching mechanism. A bottom surface of the disposing seat 1 is fixedly connected with a top end surface of the supporting leg 2, a top surface of the disposing seat 1 is fixedly connected with a bottom surface of the buffer mechanism, a top surface of the buffer mechanism is fixedly connected with a bottom surface of the disposing plate 6, and a top surface of the disposing plate 6 is fixedly connected with a bottom surface of the disposing shell 7, and a through hole 701 is defined on two opposite side surfaces of the disposing shell 7, which facilitates passing through and disposing of the line body 15, and the line body 15 is disposed on the top surface of the disposing plate 6.

The buffer mechanism includes a fixed frame 3, a chute 301, a supporting post 5 and a shock absorbing tube 4. A top surface of the fixed frame 3 is defined with the chute 301, and a side surface of the fixed frame 3 is in sliding contact with two opposite end surfaces of the shock absorbing tube 4. With the shock absorbing tube 4 being provided, shock absorbing effect can be improved, buffering of a impact force of the plunging cutter can be facilitated and operations and use also can be facilitated. An inner cavity of the chute 301 is in sliding connection with the supporting post 5. A top end surface of the supporting post 5 is fixedly connected with a bottom surface of the disposing plate 6, and a bottom end surface of the supporting post 5 is fixedly connected with a top surface of the shock absorber tube 4 made of elastic alloy steel. With the buffer mechanism being provided, buffering of a punching force generated by the punching cutter can be facilitated, stable use of the punching cutter can be ensured, and at the same time, stable use of the apparatus also can be ensured, and use needs of the operations can be met.

The limiting and clamping mechanism includes a fixed plate 8, a threaded rod 9, a rotating plate 10, a rotating rod 11, a pressing plate 12, a first electric push rod 13 and a limiting plate 14. The fixed plate 8 is fixedly connected to the two opposite side surfaces of the disposing shell 7, and a surface of the fixed plate 8 is threadedly connected with the threaded rod 9, a top end surface of the threaded rod 9 is fixedly connected with a bottom surface of the rotating plate 10. A top surface of the rotating plate 10 is fixedly connected with a bottom end surface of the rotating rod 11, a bottom end of the threaded rod 9 is rotatably connected with a top surface of the pressing plate 12. With the rotating rod 11 being provided, the rotating rod 11 is facilitated to drive the rotating plate 10 to rotate, thus the threaded rod 9 is driven by the rotating plate 10 to rotate, which facilitates adjusting the pressing plate 12 through the threaded rod 9. The pressing plate 12 is slidably connected to an inner cavity of the through hole 701. With the pressing plate 12 being limited through the through hole 701, stable adjustment of the pressing plate 12 in a vertical direction can be ensured. Two opposite side surfaces of the through hole 701 on a left side of the disposing shell 7 are provided with the first electric push rod 13, and the first electric push rod 13 is fixedly connected to a side surface of the disposing shell 7, and a output end of the first electric push rod 13 is fixedly connected to a side surface of the limiting plate 14. With the limiting and clamping mechanism being provided, adjusting of positions of the limiting plate 14 and the pressing plate 12 can be facilitated, limiting of two sides of the line by the limiting plate 14 can be facilitated, and at the same time, the line body 15 is pressed and fixed by the provided pressing plate 12, thus ensuring stability in a punching process and facilitating ease of use.

The punching mechanism includes a hydraulic cylinder 16, a clamping shell 17, a second electric push rod 18, a clamping plate 19 and a sponge pad 20. The hydraulic cylinder 16 is fixedly connected to a middle of the top surface of the disposing shell 7, and an output end of the hydraulic cylinder 16 is fixedly connected with a top surface of the clamping shell 17. With the hydraulic cylinder 16 being provided, the hydraulic cylinder 16 drives the clamping shell 17 to move, and the clamping shell 17 further pushes the punching cutter at a bottom side to cut off the line body 15, and at the same time, different shapes of the end of the line body 15 can be punched according to a shape of the punching cutter, so as to meet use requirements of workers. Two opposite side surfaces of the clamping shell 17 are fixedly connected with the second electric push rod 18, and an output end of the second electric push rod 18 is fixedly connected with the clamping plate 19. With the clamping plate 19 being provided, adjusting of a position of the clamping plate 19 can be facilitated, and then the clamping plate 19 clamps the punching cutter through the sponge pad 20, and with a surface of the punching cutter being protected by the sponge pad 20, clamping damage to the punching cutter is eliminated, operations of the workers can be facilitated. The other side surface of the clamping plate 19 is fixedly connected with the sponge pad 20. With the punching mechanism being provided, punching cutters with different shapes can be easily replaced and fixed, both stable disposing of the punching cutters after replacement and punching stability can be ensured, which presents good market value and is suitable for popularization and use.

There are four supporting legs 2, and the four supporting legs 2 are located at four corners of a bottom side of the disposing seat 1, so that the disposing seat 1 can be stably disposed with the supporting legs 2, which facilitates the disposing seat 1 being stably supported by the supporting legs 2. There are a number of the shock absorbing tubes 4, and adjacent shock absorbing tubes 4 are equally spaced and distributed in parallel, and the shock absorbing tubes 4 are slidably connected with the side surface of the fixed frame 3, which ensures compact disposing of the shock absorbing tubes 4 and improves overall shock absorbing effect. Top surfaces of two opposite ends of the shock absorbing tube 4 are fixedly connected with the supporting post 5, and the supporting posts 5 fixedly connected to the top sides of the shock absorbing tube 4 are parallel, which facilitates compact disposing of adjacent shock absorbing tubes 4 and improves the convenience. Two opposite side surfaces of the line body 15 are attached to the limiting plate 14, and a thickness of the limiting plate 14 is less than that of the line body 15, which facilitates compact disposing of the line body 15 and improves disposing stability of the line body 15. The pressing plate 12 is disposed in parallel with the fixed plate 8, and the pressing plate 12 is disposed in parallel with the disposing plate 6, so that the pressing plate 12, the fixed plate and the disposing plate 6 can be disposed compactly, and use requirements of the workers can be met. A top surface of the pressing plate 12 is provided with a rotating groove, and an inner cavity of the rotating groove is rotatably connected with a rotating block, and a top surface of the rotating block is fixedly connected with a bottom end surface of the threaded rod 9, so that adjusting of the position of the pressing plate 12 can be made through rotation adjustment of the threaded rod 9, and operations of the workers can be facilitated. A front surface of the disposing shell 7 is hinged with a disposing door through a hinge, and a front surface of the disposing door is fixedly connected with a handle, which facilitates opening of the surface of the disposing shell 7 and replacing the punching cutter by the workers. A cross section of the clamping shell 17 is U-shaped, and a top inner wall of the clamping shell 17 is slidably connected with a top surface of the clamping plate 19, which facilitates the clamping plate 19 moving on a surface of the clamping shell 17. There are two clamping plates 19, and the two clamping plates 19 are placed in parallel, which facilitates disposing and movement of the clamping plates 19.

In this disclosure, when in use, all of electrical elements in the disclosure are externally connected with a power supply and a control switch, the line body 15 is disposed on a surface of the disposing plate 6, and the first electric push rod 13 is started and pushes the limiting plates 14 to clamp both sides of the line body 15, so as to ensure that both sides of the line body 15 are limited and fixed. Meanwhile, the rotating rod 11 is rotated, and the rotating rod 11 drives the rotating plate 10 to rotate, and the rotating plate 10 drives the threaded rod 9 to rotate. The threaded rod 9 then adjusts the pressing plate 12 to slide along the chute 301, and the line body 15 is stably pressed by the pressing plate 12. Then, the punching cutter is disposed in an inner cavity of the clamping shell 17, and the second electric push rod 18 is started and pushes the clamping plate 19 to stably clamp the punching cutter in the clamping shell 17. In punching, the hydraulic cylinder 16 is started and drives the clamping shell 17 to move. The clamping shell 17 then pushes the punching cutter on the bottom side to cut off the line body 15, and at the same time, different shapes can be punched at an end of the line body 15 according to a shape of the punching cutter, so as to meet use requirements of the workers. After the punching cutter punches the line body 15, an impact force is transmitted to the shock absorbing tube 4 through the supporting posts 5 on the bottom side, and a punching force is buffered by the shock absorbing tube 4, thus ensuring overall operating stability of the apparatus and ease of operations.

With above schemes, the manufacturing apparatus of the molding line is novel in structural design and simple in structure, and with the buffer mechanism being provided, buffering of the punching force generated by the punching cutter can be facilitated, thus ensuring stable use of the punching cutter, ensuring stable use of the apparatus at the same time, and meeting the use requirements of the operations. When in use, with the limiting and clamping mechanism being provided, adjusting of positions of the limiting plate 14 and the pressing plate 12 can be facilitated, so that both sides of the line can be limited by the limiting plate 14, and at the same time, the line body 15 is pressed and fixed by the provided pressing plate 12, thus ensuring stability in a punching process and facilitating ease of use. In addition, with the punching mechanism being provided, punching cutters with different shapes can be easily replaced and fixed, both stable disposing of the punching cutters after replacement and punching stability can be ensured, which presents good market value and is suitable for popularization and use. Involved circuits, electronic elements and modules all belong to the prior art, which can be completely realized by those skilled in the art, which will not be repeatedly described herein. In this disclosure does, improvements of software and methods are not involved.

The above is only preferred embodiments of this application, and is not intended to limit this application, and modifications and variations can be made in this application for those skilled in the art. Any modification, equivalent substitution, improvement, etc. made within the spirit and principle of this application shall be encompassed within the protection scope of this application.

1. A molding line, wherein the molding line comprises a line body extending along a first direction, and the line body comprises a first modeling layer part, a second modeling layer part and a connecting part;
wherein in a cross section perpendicular to the first direction, the first modeling layer part and the second modeling layer part extend along a second direction, the first modeling layer part is located at an outer side opposite to the second modeling layer part, and the connecting part is connected between the first modeling layer part and the second modeling layer part and obliquely intersects with the second direction; and
an inwardly recessed molding groove is provided at a joint of the connecting part and the first molding layer part or/and the second molding layer part.

2. The molding line according to claim 1, wherein:
the molding groove is a V-shaped groove.

3. The molding line according to claim 1, wherein:
the molding groove extends along the first direction.

4. The molding line according to claim 1, wherein:
the connecting part is of a linear structure.

5. The molding line according to claim 1, wherein:
the connecting part is of an arc structure.

6. A manufacturing apparatus for manufacturing the molding line according to claim 1, wherein:
the manufacturing apparatus comprises: a disposing seat (1), a supporting leg (2), a buffer mechanism, a disposing plate (6), a disposing shell (7), a limiting and clamping mechanism and a punching mechanism, wherein a bottom surface of the disposing seat (1) is fixedly connected with a top end surface of the supporting leg (2), a top surface of the disposing seat (1) is fixedly connected with a bottom surface of the buffer mechanism, a top surface of the buffer mechanism is fixedly connected with a bottom surface of the disposing plate (6), and a top surface of the disposing plate (6) is fixedly connected with a bottom surface of the disposing shell (7), and a through hole (701) is defined on two opposite side surfaces of the disposing shell (7), and a line body (15) is disposed on the top surface of the disposing plate (6);
the buffer mechanism comprises a fixed frame (3), a chute (301), a supporting post (5) and a shock absorbing tube (4), a top surface of the fixed frame (3) being defined with the chute (301), a side surface of the fixed frame (3) being in sliding contact with two opposite end surfaces of the shock absorbing tube (4), and an inner cavity of the chute (301) being in sliding connection with the supporting post (5), a top end surface of the supporting post (5) being fixedly connected with a bottom surface of the disposing plate (6), and a bottom end surface of the supporting post (5) being fixedly connected with a top surface of the shock absorber tube (4) made of elastic alloy steel;
the limiting and clamping mechanism comprises a fixed plate (8), a threaded rod (9), a rotating plate (10), a rotating rod (11), a pressing plate (12), a first electric push rod (13) and a limiting plate (14), the fixed plate (8) being fixedly connected to the two opposite side surfaces of the disposing shell (7), and a surface of the fixed plate (8) being threadedly connected with the threaded rod (9), a top end surface of the threaded rod (9) being fixedly connected with a bottom surface of the rotating plate (10), a top surface of the rotating plate (10) being fixedly connected with a bottom end surface of the rotating rod (11), a bottom end of the threaded rod (9) being rotatably connected with a top surface of the pressing plate (12), the pressing plate (12) being slidably connected to an inner cavity of the through hole (701), two opposite side surfaces of the through hole (701) on a left side of the disposing shell (7) being provided with the first electric push rod (13), and the first electric push rod (13) being fixedly connected to a side surface of the disposing shell (7), and a output end of the first electric push rod (13) being fixedly connected to a side surface of the limiting plate (14); and
the punching mechanism comprises a hydraulic cylinder (16), a clamping shell (17), a second electric push rod (18), a clamping plate (19) and a sponge pad (20), the hydraulic cylinder (16) being fixedly connected to a middle of the top surface of the disposing shell (7), and an output end of the hydraulic cylinder (16) being fixedly connected to a top surface of the clamping shell (17), two opposite side surfaces of the clamping shell (17) being fixedly connected with the second electric push rod (18), an output end of the second electric push rod (18) being fixedly connected with the clamping plate (19), and the other side surface of the clamping plate (19) being fixedly connected with the sponge pad (20).

7. The manufacturing apparatus of the molding lines according to claim 6, wherein:
there are four supporting legs (2), and the four supporting legs (2) are located at four corners of a bottom side of the disposing seat (1).

8. The manufacturing apparatus of the molding lines according to claim 6, wherein:
there are a number of the shock absorbing tubes (4), and adjacent shock absorbing tubes (4) are equally spaced and distributed in parallel, and the shock absorbing tubes (4) are slidably connected with the side surface of the fixed frame (3).

9. The manufacturing apparatus of the molding lines according to claim 6, wherein:
top surfaces of two opposite ends of the shock absorbing tube (4) are fixedly connected with the supporting post (5), and the supporting posts (5) fixedly connected to the top sides of the shock absorbing tube (4) are parallel.

10. The manufacturing apparatus of the molding lines according to claim 6, wherein:
two opposite side surfaces of the line body (15) are attached to the limiting plate (14), and a thickness of the limiting plate (14) is less than a thickness of the line body (15).
